(19) United States
(12) Patent Application Publication
(10) Pub. No.: US 2018/0123924 A1
(43) Pub. Date: May 3, 2018

(54) CLUSTER SERVER MONITORING SYSTEM AND METHOD

(71) Applicants: HONGFUJIN PRECISION ELECTRONICS (TIANJIN) CO.,LTD., Tianjin (CN); HON HAI PRECISION INDUSTRY CO., LTD., New Taipei (TW)

(72) Inventor: KUN-MING LIN, New Taipei (TW)

(21) Appl. No.: 15/338,470

(22) Filed: Oct. 31, 2016

(51) Int. Cl. H04L 12/26; H04L 29/08; H04L 12/58; H04L 12/24

(52) U.S. Cl. CPC H04L 43/0817; H04L 67/1034; H04L 43/045; H04L 41/0686; H04L 67/16; H04L 51/30

(57) ABSTRACT

A cluster server monitoring system in relation to services which should be constantly available to clients includes at least one server, a scanning unit, a detection unit, an accessing unit, a determining unit, and a setting unit. The scanning unit scans at least one server node of a predetermined IP network segment and the plurality of services of that at least one node. The detection unit detects a trigger event, which is a client selecting a particular service or group of services. The accessing unit accesses the plurality of services upon a trigger event and the determining unit determines whether one of the plurality of the services is failed. The setting unit provides failure details and solutions in relation to the failed service when one service is failed. A cluster server monitoring method is also provided.

### FIELD

The subject matter herein generally relates to monitoring systems.

### BACKGROUND

A cluster server monitoring system is used to monitor a plurality of services of a cluster server system to obtain a state of each service of each server. The state of each service comprises a failed state and a normal-operation state.

### BRIEF DESCRIPTION OF THE DRAWINGS

Implementations of the present technology will now be described, by way of example only, with reference to the attached figures.

FIG. 1 is a block diagram of one exemplary embodiment of a cluster server monitoring system and a server terminal.

FIG. 2 is a display diagram of one exemplary embodiment of a node display interface of the monitoring system of FIG. 1.

FIG. 3 is a display diagram of one exemplary embodiment of a service display interface of the monitoring system of FIG. 1.

FIG. 4 is a diagram of one exemplary embodiment of an information display interface of the monitoring system of FIG. 1.

FIG. 5 is a block diagram of one exemplary embodiment of a cluster server monitoring method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to a cluster server monitoring system. The cluster server monitoring system is used to monitor a plurality of services of server nodes to determine whether failed services exist.

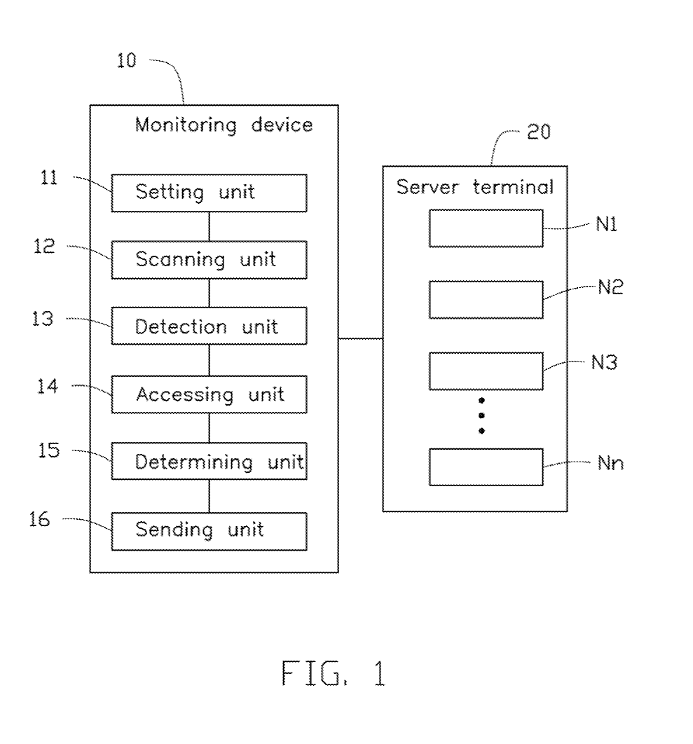

FIG. 1 illustrates an exemplary embodiment of a cluster server monitoring system. The cluster server monitoring system comprises a monitoring device 10 and server terminal 20. The monitoring device 10 communicates with the server terminal 20 by network connections. The server terminal 20 is a cluster server system and comprises at least one server. Each server corresponds to a node. The server terminal 20 comprises a plurality of nodes, such as a first node N1, a second node N2, a third node N3, . . . , and a node Nn. The monitoring device 10 monitors services of each node of the server terminal 20. Each node corresponds to a unique internet protocol (IP) address. Each node is located in an IP network segment. The monitoring device 10 comprises a setting unit 11, a scanning unit 12 coupled to the setting unit 11, a detection unit 13 coupled to the scanning unit 12, an accessing unit 14 coupled to the detection unit 13, a determining unit 15 coupled to the accessing unit 14, and a sending unit 16 coupled to the determining unit 15.

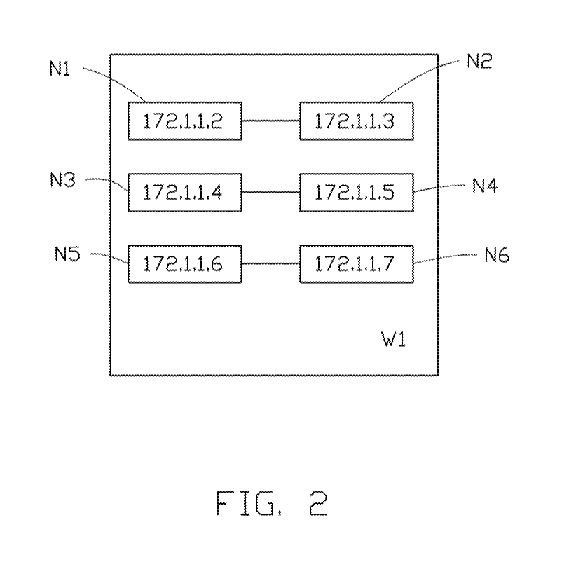

The setting unit 11 is configured to set a predetermined IP network segment and set predetermined clients. A plurality of nodes are located in the predetermined IP network segment, such as the first node N1, the second node N2, the third node N3, a fourth node N4, a fifth node N5, a sixth node N6, . . . and a node Nm. The scanning unit 12 is configured to scan each node in the predetermined IP network segment. Each node corresponds to one node icon. A node display interface W1 displays each node icon corresponding to the scanned node and the IP address corresponding to the scanned node. Each node has a plurality of services. The scanning unit 12 is further configured to scan a plurality of services of each node to obtain the plurality of services corresponding to each node. The setting unit 11 further is configured to mark the scanned nodes with the same services. FIG. 2 illustrates that in one exemplary embodiment, the scanning unit 12 scans six nodes, namely the first node N1, the second node N2, the third node N3, the fourth node N4, the fifth node N5, and the sixth node N6. The six IP addresses respectively corresponding to the six nodes are: 172.1.1.2, 172.1.1.3, 172.1.1.4, 172.1.1.5, 172.1.1.6, and 172.1.1.7. The first node N1 and the second node N2 have the same services. The setting unit 11 marks the first node N1 and the second node N2 on the node display interface W1. The third node N3 and the fourth node N4 have the same services. The setting unit 11 marks the third node N3 and the fourth node N4 on the node display interface W1. The fifth node N5 and the sixth node N6 have the same services. The setting unit 11 marks the fifth node N5 and the sixth node N6 on the node display interface W1.

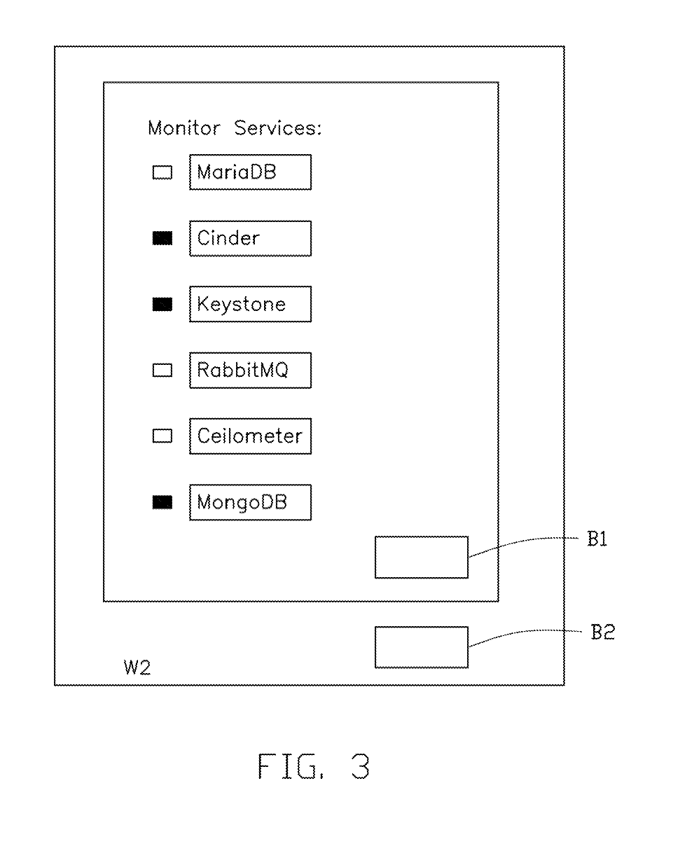

A trigger event is generated by a user after a plurality of services are selected by the user. Specifically, a plurality of default services can be selected by the user, or a plurality of different services can be selected by the user or be added by the user. FIG. 3 illustrates that a plurality of services of each node are displayed on a service display interface W2. The service display interface W2 displays a plurality of services, an option button B1, and an executing button B2. A plurality of default services can be selected by the user, or a plurality of different services can be selected by the user or be added by triggering the option button B1. The executing button B2 can then be clicked by the user to generate the trigger event. In one exemplary embodiment, the user can obtain the services of the second node N2 by double-clicking the second node icon. The services of the second node N2 are MariaDB, Cinder, Keystone, RabbitMQ, Ceilometer, and MongoDB. These services are displayed on the service display interface W2. Specifically, the default options are the Cinder, the Keystone, and the MongoDB. The user can select different or additional services, such as the MariaDB, the RabbitMQ, and the Ceilometer. The user can add other services by clicking the option button B1. The user can trigger the executing button B2 to generate a trigger event after the user selects at least one service.

The detection unit 13 detects the occurrence of a trigger event. The detection unit 13 sends a signal to the accessing unit 14 after detecting the trigger event, thus the accessing unit 14 accesses the plurality of services of each node. The determining unit 15 determines whether the plurality of services, or any one of them, of each node is failed. Specifically, the determining unit 15 is configured to determine whether a state of each service is in a failed state.

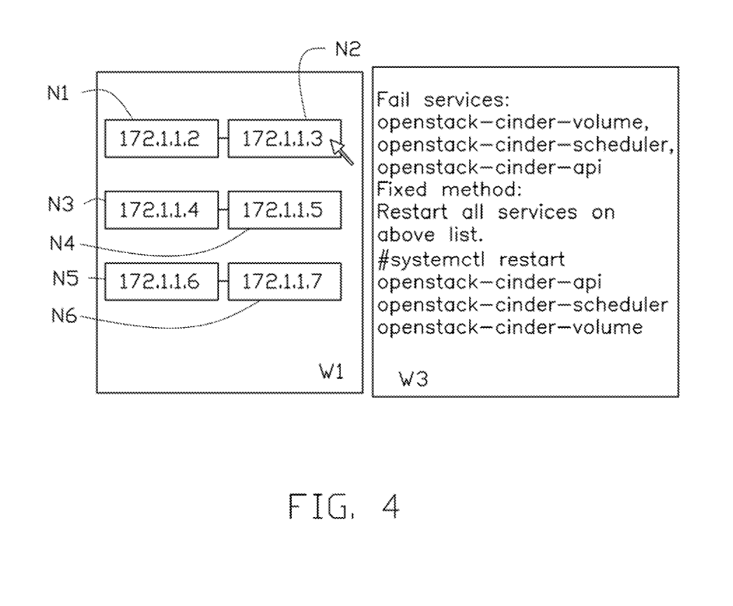

The setting unit 11 is further configured to set an original color of each node icon. In one exemplary embodiment, the original color of each node icon is green. When the determining unit 15 determines that one service of one node is in the failed state, the setting unit 11 changes the color of the node icon corresponding to the failed service. The unit 15 also provides information corresponding to the failed service, and provides solutions in relation to the failed service. FIG. 4 illustrates that the information as to failure and the solutions can be displayed on an information display interface W3 after the user triggers the node icon of the failed node. The sending unit 16 is configured to send prompts and/or emails to predetermined clients. Specifically, the information of the prompt or email can indicate the failed node, the IP of the failed node, and the failed services of the failed node. In one exemplary embodiment, the setting unit 11 changes the color of the second node icon to be red when the services of the second node N2 are failed. The colors of other node icons which have not a failed service remain green. The user can place a cursor (not shown) on the second node icon, and the information as to failure and the solutions for the second node N2 are displayed on the information display interface W3. The information as to failure of the second node N2 may be openstack-cinder-volume, openstack-cinder-scheduler, and openstack-cinder-api. The solutions for the failed services may be: Restart all services on above list.

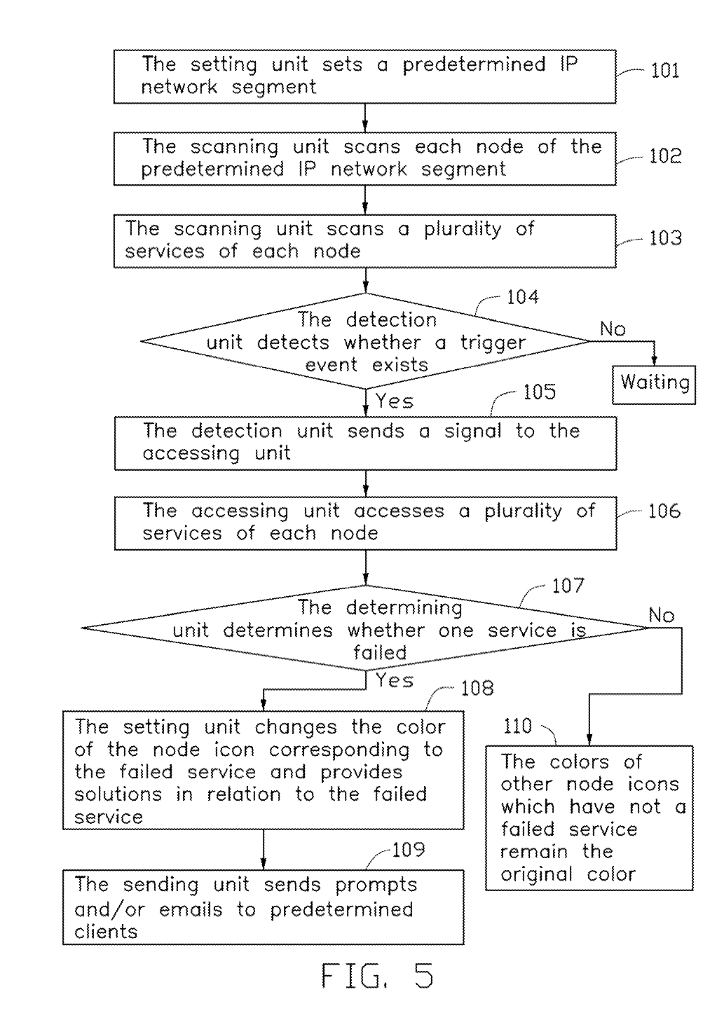

FIG. 5 illustrates a flowchart of a method in accordance with an example embodiment. A cluster server monitoring method is provided by way of example, as there are a variety of ways to carry out the method. The cluster server monitoring method described below can be carried out using the configurations illustrated in FIGS. 1-4, for example, and various elements of these figures are referenced in explaining operating system installation method. The illustrated order of blocks is by example only and the order of the blocks can change. Additional blocks may be added or fewer blocks may be utilized without departing from this disclosure. The cluster server monitoring method can begin at block 101.

At block 101, the setting unit 11 sets a predetermined IP network segment.

At block 102, the scanning unit 12 scans each node of the predetermined IP network segment.

At block 103, the scanning unit 12 scans a plurality of services of each node to obtain the plurality of services of each node.

At block 104, the detection unit 13 detects whether a trigger event a trigger event exists. If yes, the method goes to block 105; if no, the cluster server monitoring system remains waiting. Specifically, a plurality of default services can be selected automatically, or a plurality of different services can be selected by the user or be added by the user; then the executing bottom B2 is clicked by the user to generate the trigger event.

At block 105, the detection unit 13 sends a signal to the accessing unit 14.

At block 106, the accessing unit 14 accesses a plurality of services of each node.

At block 107, the determining unit 15 determines whether one service is failed. If yes, the method goes to block 108; if no, the method goes to block 110.

At block 108, the setting unit 11 changes the color of the node icon corresponding to the failed service and provides solutions in relation to the failed service.

At block 109, the sending unit 16 sends prompts and/or an email to predetermined clients. Specifically, the information comprises

At block 110, the colors of other node icons which have not a failed service remain to be the original color.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A cluster server monitoring system comprising:
at least one server; and
a monitoring device configured to communicate with the at least one server and comprising:
a scanning unit configured to:
scan at least one server node of a predetermined internet protocol (IP) network segment; and
scan a plurality of services of the at least one node;
a detection unit coupled to the scanning unit;
an accessing unit configured to access the plurality of services;
a determining unit coupled to the scanning unit; and
a setting unit coupled to the scanning unit;
wherein the detection unit coupled to the scanning unit and configured to detect a trigger event;
wherein the determining unit configured to determine whether one of the plurality of services is failed;
wherein the setting unit is configured to provide solutions in relation to a failed service when one of the plurality of services is determined to be failed.

2. The cluster server monitoring system of claim 1, further comprising a sending unit, wherein the sending unit is configured to send an email to a predetermined client after the setting unit provides the solutions.

3. The cluster server monitoring system of claim 1, wherein the setting unit is further configured to set the predetermined IP network segment before the scanning unit scans the at least one server node of the predetermined IP network segment.

4. A cluster server monitoring system comprising:
a server terminal comprising at least one server; and
a monitoring device configured to communicate with the at least one server and comprising:
a setting unit configured to set a predetermined internet protocol (IP) network segment;
a scanning unit configured to:
scan at least one server node of the predetermined IP network segment; and
scan a plurality of services of the at least one node;
a detection unit configured to detect a trigger event;
an accessing unit coupled to the detection unit; and
a determining unit coupled to the scanning unit;
wherein accessing unit configured to access the plurality of services;
wherein the determining unit configured to determine whether one of the plurality of services is failed;
wherein the setting unit is configured to provide solutions in relation to a failed service when one of the plurality of services is determined to be failed.

5. The cluster server monitoring system of claim 4, wherein the setting unit is further configured to change a color of the node icon corresponding to the failed service.

6. The cluster server monitoring system of claim 4, wherein the server terminal is a cluster server system.

7. A cluster server monitoring method comprising:
scanning at least one node of a predetermined internet protocol (IP) network segment;
scanning a plurality of services of the at least one node;
detecting a trigger event;
accessing the plurality of services;
determining whether one of the plurality of services is failed;
providing solutions in relation to a failed service when one of the plurality of the services is failed.

8. The cluster server monitoring method of claim 7, further comprising a step of setting the predetermined IP network segment before scanning the at least one node of a predetermined IP network segment.

9. The cluster server monitoring method of claim 7, further comprising a step of sending emails to predetermined clients after providing solutions.

10. The cluster server monitoring method of claim 7, further comprising a step of sending information to predetermined clients after providing solutions.

11. The cluster server monitoring method of claim 7, further comprising a step of adding a plurality of different services before detecting a trigger event.

12. The cluster server monitoring method of claim 7, further comprising a step of selecting a plurality of different services before detecting a trigger event.

13. The cluster server monitoring method of claim 7, further comprising a step of changing a color of the node corresponding to the failed service after determining one of the plurality of the services is failed.

14. The cluster server monitoring method of claim 13, further comprising a step of keeping the color of the node icon to be an original color after determining no one service of a node is failed.

15. A cluster server monitoring method comprising:
scanning a plurality of services of at least one node;
detecting a trigger event;
accessing the plurality of services;
determining whether one of the plurality of services is failed;
providing solutions in relation to the failed service when one of the plurality of the services is failed.

16. The cluster server monitoring method of claim 15, further comprising a step of scanning the at least one node of a server terminal before scanning the plurality of services of the at least one node.

17. The cluster server monitoring method of claim 16, further comprising a step of setting a predetermined internet protocol (IP) network segment before scanning the at least one node.

18. The cluster server monitoring method of claim 15, further comprising a step of sending emails to predetermined clients after providing solutions.

19. The cluster server monitoring method of claim 15, further comprising a step of adding a plurality of different services before detecting a trigger event.

20. The cluster server monitoring method of claim 15, further comprising a step of changing a color of the node corresponding to the failed service after determining one service is failed.
